(19) United States
(12) Patent Application Publication
(10) Pub. No.: US 2024/0370710 A1
(43) Pub. Date: Nov. 7, 2024

(54) ARTIFICIAL-INTELLIGENCE-BASED EXECUTION ON BLOCKCHAINS

(71) Applicant: Ava Labs, Inc., New York, NY (US)

(72) Inventors: John Morrisett, New York, NY (US); Emin Gün Sirer, Ithaca, NY (US); Patrick Robert O’Grady, Palo Alto, CA (US)

(21) Appl. No.: 18/653,171

(22) Filed: May 2, 2024

Related U.S. Application Data
(60) Provisional application No. 63/463,472, filed on May 2, 2023.

(51) Int. Cl. G06N 3/0475

(52) U.S. Cl. CPC G06N 3/0475

(57) ABSTRACT

Various aspects of the subject technology relate to systems, methods, and machine-readable media for writing transactions, including smart contracts, on a blockchain platform. Various aspects may include receiving a natural language input specifying a transaction to be performed on a blockchain. Aspects may also include determining, using a machine learning (ML) model, an intent of the transaction and contextual information associated with the transaction based on the natural language input. Aspects may also include determining actions (e.g., constraints/conditions) corresponding to the natural language input transaction based on the intent and the contextual information. Aspects may also include executing the transaction on the blockchain based on the actions.

### CROSS-REFERENCE TO RELATED APPLICATIONS

The present disclosure is related and claims priority under 35 U.S.C. § 119 (e), to U.S. Provisional Patent Application No. 63/463,472, entitled ARTIFICIAL-INTELLIGENCE-BASED BLOCKCHAIN AND SMART CONTRACT ARCHITECTURE WITH COIN OPERATED AGENTS FOR A BROAD USER BASE, to John Morrisett et al., filed on May 2, 2023, the contents of which are hereby incorporated by reference in their entirety, for all purposes.

### TECHNICAL FIELD

The present disclosure generally relates to blockchain network architectures that use artificial-intelligence/machine learning (AI/ML) algorithms to broaden the user base via machine-user interactions. More specifically, the present disclosure is directed to blockchain architectures including smart contracts and coin operated agents that incorporate large language models (LLMs) to facilitate their use and handling by non-experts, thus broadening the user base.

### BACKGROUND

Use of blockchain networks has proven highly effective to provide trust-based environments for online applications, such as smart contracts, cryptocurrency transactions, and the like. However, the user base of these systems is largely constrained to programming experts with a high degree of knowledge in current cryptography techniques and network-based coding. This fact precludes the widespread use of blockchain technologies and its world-wide adoption by the general public.

### BRIEF SUMMARY

The subject disclosure provides for systems and methods for issuing transactions, writing smart contracts, or the like, in human readable language by capturing their intent using LLM. According to embodiments, LLMs are provided to interpret the natural language input, introducing natural language processing capabilities to the blockchain architecture. When interpreting transactions, the necessary context is already encoded into the state built into the LLMs. This significantly simplifying the creation and execution of transactions/smart contracts on the blockchain. Leveraging the LLMs obviates programming and translation steps (e.g., to machine-executable code), providing low latency interactions with the blockchain network. The LLM-based smart contracts and transactions may take many forms, including high level code, or a list of text-based prompts/instructions that may be stored as necessary context for the LLM.

According to embodiments, a computer-implemented method for implementing transactions in a blockchain platform is provided. The method includes receiving a natural language input specifying a transaction to be performed on a blockchain. The method also includes determining, using a ML model, an intent and contextual information associated with the transaction based on the natural language input. The method also includes determining actions corresponding to the natural language input based on the intent and the contextual information. The method also includes executing the transaction on the blockchain based on the actions.

According to embodiments, a system is provided including a processor and a memory comprising instructions stored thereon, which when executed by the processor, cause the processor to perform a method for implementing transactions in a blockchain platform. The method includes receiving a natural language input specifying a transaction to be performed on a blockchain. The method also includes determining, using an LLM, an intent and contextual information associated with the transaction based on the natural language input. The method also includes determining actions corresponding to the natural language input based on the intent and the contextual information. The method also includes executing the transaction on the blockchain based on the actions.

According to embodiments, a non-transitory computer-readable storage medium is provided including instructions (e.g., stored sequences of instructions) that, when executed by a processor, cause the processor to perform a method for implementing transactions in a blockchain platform. The method includes receiving a natural language input specifying a transaction to be performed on a blockchain. The method also includes determining, using an LLM embedded within validators of the blockchain, an intent and contextual information associated with the transaction based on the natural language input. The method also includes determining actions corresponding to the natural language input based on the intent and the contextual information. The method also includes executing the transaction on the blockchain based on the actions.

According to one embodiment of the present disclosure, a system is provided that includes means for storing instructions, and means for executing the stored instructions that, when executed by the means, cause the means to perform a method for implementing transactions in a blockchain platform. The system also includes a means for receiving a natural language input specifying a transaction to be performed on a blockchain. The system also includes a means for determining, using a ML model (e.g., a LLM), an intent and contextual information associated with the transaction based on the natural language input. The system also includes a means for determining actions corresponding to the natural language input based on the intent and the contextual information. The system also includes a means for executing the transaction on the blockchain based on the actions.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a block diagram of a device operating environment with which aspects of the present disclosure can be implemented.

FIG. 2 is a block diagram illustrating details of devices used in the architecture of FIG. 1, according to some embodiments.

FIG. 3 is a block diagram illustrating a blockchain system for implementing transactions in a blockchain platform, according to certain aspects of the present disclosure.

FIG. 4 is an example flow diagram for implementing transactions in a blockchain platform, according to certain aspects of the present disclosure.

FIG. 5 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

### General Overview

Blockchain platforms may host and execute computer programs, such as smart contracts, and process transactions. Smart contracts may consist of code that specifies predetermined conditions, and when those conditions are met, the smart contract automatically executes the agreed-upon actions. Blockchain platforms may require a consensus protocol as a fundamental building block for building distributed systems. As an example, a blockchain platform can include multiple blockchains, such as a component exchange blockchain for creating and trading digital smart assets, a metadata blockchain for coordinating validators as well as tracking and creating subnets, and a contract blockchain for creating smart contracts. As used herein, a subnet or subnetwork includes a dynamic set of nodes (e.g., one or more validators) seeking to achieve consensus on a state of a set of blockchains. Validators are responsible for verifying new blocks of transactions and adding them to the blockchain. The validators confirm the authenticity and accuracy of the transaction records before they are permanently added to the blockchain. As such, validators play a crucial role in maintaining the security, transparency, and integrity of the blockchain network.

Blockchain platforms feature application-level logic that is defined by multiple virtual machines (VMs). The VM-based architecture enables more decentralized networks. In particular, a blockchain may be an instance of a VM that specifies the blockchain's state, state transition function, transactions, and application programming interface (API) for user interaction. The VM allows for the execution of smart contracts and decentralized applications on the blockchain, providing a secure and deterministic environment for code execution and enabling interoperability between blockchains. This VM is the core component that defines the application-level logic of the blockchain. Blockchains utilize the VMs to execute low-level, machine-readable code that represents transactions and smart contracts. The code may include various operations and instructions, which are interpreted and processed by the VM.

When executing a transaction or smart contract, the VM starts with a blank computational state, requiring developers to encode all application logic into the machine code. This means the VM has no prior context or knowledge about the application or the state of the blockchain. The VM operates solely based on the instructions provided in this low-level code, without any additional context or interpretation. This places a significant burden on developers, as they must account for every possible scenario and state change within the application. Developers cannot rely on any high-level abstractions or pre-existing logic to alleviate this burden. The developer must meticulously define every function and operation of the transaction or smart contract in the VM code. This level of granularity and lack of higher-level abstractions contributes to the complexity and challenge of creating applications (e.g., smart contacts) on blockchain platforms, as developers must account for every possible state and transition within the VMs execution.

Errors may be introduced at multiple levels during the development and execution of smart contracts. For instance, a user's high-level understanding of a smart contract's functionality may not align with the actual implementation details. This mismatch between the user's perception and the contract's intent can lead to errors. The specialized programming required to capture the contract's operational logic, runtime, and execution environment necessitates skilled developers. This reliance on human programmers introduces the potential for coding errors. Additionally, compilers are responsible for translating the programming language code into the bytecode that can be executed by the blockchain. Errors in the compiler can have catastrophic consequences, even for smart contracts that have been thoroughly audited. Many failures stem from a semantic gap between the user's intent, the smart contract code, and the final executable bytecode. Any mismatch between these layers can lead to problematic outcomes.

Overcoming these issues is crucial for ensuring the reliability and security of smart contracts and blockchain applications, as well as facilitating their use and handling by non-experts and broadening the user base.

Embodiments, as disclosed herein, provide a solution to the above-mentioned problems rooted in computer technology, namely, transaction and smart contract execution in a blockchain platform. The disclosed subject technology improves the functioning of the computer itself by providing a blockchain architecture that integrates Artificial Intelligence (AI), Machine Learning (ML), and Large Language Models (LLMs) to support enhanced transaction processing and smart contract creation. The blockchain architecture described herein may be built as a subnet. According to embodiments, LLMs may be embedded within validators of a blockchain. The LLMs may be trained on a vast corpus of data. The training process involves the model ingesting and learning from extensive datasets from a variety of sources (e.g., available human generated content on the Internet). This equips the validators with improved abilities to understand, process, and leverage relevant information aligned with the application goals (e.g., intent for a smart contract).

The disclosed subject technology further provides improvements to the technological field by broadening the user base via machine-user interactions and improving how users interact with blockchains, thereby making the blockchain architecture accessible to non-expert users. According to embodiments, the LLMs provide natural language processing capabilities to the blockchain architecture. Further, when interpreting transactions, the necessary context is already encoded into the state built into the LLMs. Validators may utilize the LLMs to interpret input transactions expressed in natural language and execute the transaction based on the human language specifications.

According to embodiments, users may specify application objectives in natural language using an LLM. The LLM interpret these objectives and processes them based on the available human knowledge captured by the trained LLM. The blockchain validators can automatically execute the transaction based on an understanding of the user's objectives. This approach allows the blockchain architecture to expand its user base beyond, for example, proficient developers while bridging the gap between the functionality of an application and its actual executable functions.

According to embodiments, each transaction may be part of a sequence of related transactions. Each sequence is assigned a unique identifier which can be used to access, modify (e.g., add a transaction to the chain), or reference the sequence. By non-limiting example, new transactions (or subsequent interactions) may utilize the sequence identifier assigned during the creation of the given sequence to relate the new transaction to the sequence. The start of a new sequence may be initiated by the user. In some implementations, a sequence ID of 0 indicates that the transaction intends to create a new sequence. This allows the blockchain architecture to organize and manage the transactions in a structured, sequential manner.

According to embodiments, each validator in a blockchain may utilize a precise version of the LLM. The version may be specified implicitly and exogenously to the system or on the blockchain by the user (or application) submitting the transaction. In some implementations, a version is specified once in the genesis block for all blocks and serves as common ground for transactions on that chain (e.g., a sequence of related transactions). In some implementations, each sequence creation specifies the version to be used for that sequence.

In some implementations, validators run a single LLM for each transaction. In some implementations, validators run multiple LLMs for each transaction. One or more of the multiple LLMs may produce potentially divergent interpretations (or actions) for a given transaction. In this case, embodiments may implement a resolution protocol. By non-limiting example, the resolution protocol may revert the transaction based on ambiguity in the actions. Reverting the transaction halts the execution of the transaction and removes any state change based on the transaction. By non-limiting example, the resolution protocol may take an intersection of the actions. The transaction may then be executed based on the intersection.

According to embodiments, validators of the blockchain may enable probabilistic checking. In a typical blockchain, all other validators check the state transition and vote on the validity of a block proposed by one validator. With probabilistic checking, one validator may post a block, the transactions in the block, and the new state root, and other validators adopt it as a given correct state transition after a challenge period has passed. During the challenge period, the other validators may call out the state transition as invalid. Probabilistic checking of validators' work may be useful in reducing costs associated with running AI/ML components.

The present disclosure is directed to methods and systems for specifying transactions and smart contracts in human readable language by capturing their intent. This obviates programming and translation steps where errors have traditionally crept in, providing low latency interactions with the blockchain network. That is, the user or system need not perform a translation from the input language into a programming language or executable bytecode because the LLM captures and leverages available human knowledge through its training set. Similar to a human trustee or executor, the system instantiates the LLM within each interaction sequence that operates with the same sensibilities, contextual awareness, and implied understandings as a human would. This differs widely from traditional computer programs, which simply execute their predefined instructions without any inherent sense of higher purpose or underlying intent. Similarly, traditional smart contract environments may often run into coding errors because code is law and does not account for user intent. The blockchain architecture described herein makes it possible to appeal to the learned knowledge of the LLM to ensure that it stays true to the original intentions of its creator.

The implementation techniques disclosed herein further lend themselves to an efficient runtime performance after training by allowing the LLMs to process text input quickly. The implementation of LLMs also makes interacting with, for example, smart contracts possible for a lay person who can read and write. This, in turn, has the potential to extend the benefits of blockchain networks to a broader population of users.

As used herein, the term “blockchain” generally refers to an open and distributed public ledger comprising a growing list of records, which are linked using cryptography. By design, the blockchain is resistant to modification of the data. The blockchain can include an auditable database that provides a distributed, replicated ledger of cryptographically certified artifacts whose contents are extremely difficult to tamper with without detection, and therefore, are with very high probability, true copies of the intended content, and whose content are open for inspection via a suitable query interface.

As used herein, the term “block” generally refers to a record that is kept in a blockchain. For example, each block contains a cryptographic hash of the previous block, a timestamp, and transaction data, which can generally be represented as a Merkle tree root hash.

In some embodiments, the term “subnet” or “subnetwork” generally refers to a dynamic set of validators working together to achieve consensus on a state of a set of blockchains. For example, each blockchain is validated by exactly one subnet. A subnet can validate arbitrarily many blockchains. A validator node may be a member of arbitrarily many subnets. A subnet may manage its own membership and it may require that its constituent validators have certain properties.

In some embodiments, a customized blockchain may include a VM marketplace having subnets serviced by unique VM modules that allow users to create feature sets directed to specific needs. For example, a gaming application in the VM marketplace will have different VM modules than a finance application.

### Example System Architecture

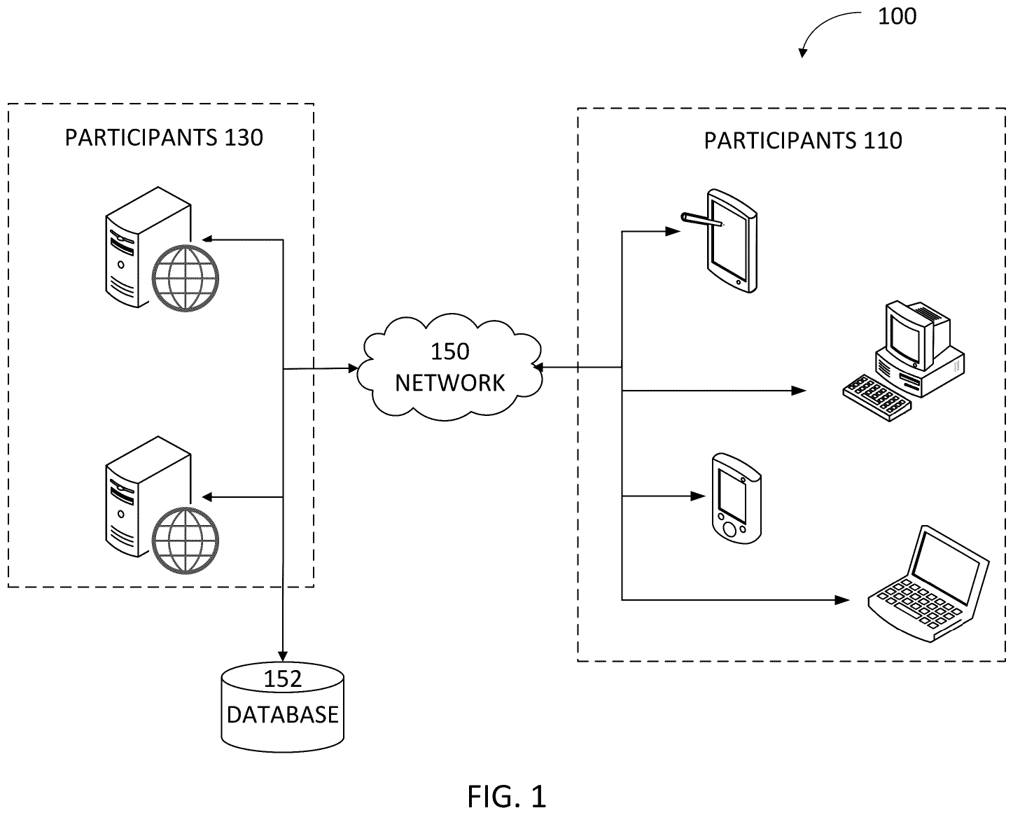

FIG. 1 illustrates an exemplary network architecture 100 used to provide a blockchain platform (e.g., blockchain network implementation) handling blockchains, according to embodiments. The network architecture 100 of FIG. 1 includes one or more participants 110 and one or more participants 130 which are communicatively coupled through the network 150. A blockchain of the network architecture 100 can be a distributed database that maintains a continuously growing list of ordered records (e.g., transactions) as the blocks. The blockchain may be a linear chain of blocks of the same dimension, such as the same height, size, length, etc. Blocks of the blockchain may comprise or store data or organized information (e.g., records of information), including a cryptographic hash of the previous block, a timestamp, and transaction data, for example. Features of the blockchain network architecture 100 may leverage AI/ML models (more specifically, LLMs) to create smart contracts hosted on one or more blockchains based on natural language specifications using one or more LLMs embedded in each of the blockchain validators.

Participants 130 may host a blockchain or an application running on participants 110, used by one or more of participants in the blockchain platform. The participants 130 may include a cloud server or a group of cloud servers. The participants 130 may provide services such as Internet based services including web2 services and web3 services, for example, to the participants 110. As such, the participants 130 may implement a computer application for a smart contract, cryptocurrency-based services, transaction services, payment services, look up services, data services, query services, and/or the like. In some implementations, the participants 130 may not be cloud-based servers (i.e., may be implemented outside of a cloud computing environment) or may be partially cloud-based. As an example, the participants 130 can function as validators. As an example, the participants 130 may be VMs that form nodes of the blockchain network architecture 100. The participants 110 that function as nodes can run software to verify block and transaction data, store data, validate, respond to network requests for data, and/or the like for the existing blockchain. VMs can be computers that run on blockchains and allow smart contracts from multiple sources to interact with one another. The participants 130 send messages or issue transactions upon request by the participants 110. The messages may be validated by a validator of the blockchain network.

Participants 110 may include any one of a laptop computer, a desktop computer, or a mobile device such as a smart phone, a palm device, or a tablet device. As an example, participants 110 may be clients of the blockchain platform for creating, expanding, or otherwise modifying customized blockchain networks and/or private or public blockchains. The participants 130 can generate blocks upon request by the participants 110, such as via a smart contract engine or module of the participants 130 at a particular time such as during a specified temporal submission window (e.g., a window that enables prescription transfers). The participants 130 may be configured to implement multiple chains of the blockchain.

According to embodiments, the linear chain of blocks making up a blockchain may consist of a genesis block, followed by blocks that contain free-form transaction types, signed by public-private keys, that contain arbitrary textual inputs. This chain is implemented by, and the transactions executed on, a collection of distributed validators, each of which runs LLMs. A public key and a private key may be linked, such that the public key is universally accessible, and the private key is hidden and only available to the specific user. In some embodiments, if a message is signed by the private key, the signature must be able to uniquely be traced to the public key. In order to be accepted into a block, a transaction must be signed using the user's private key and included with the base transaction.

Validators maintain an associative array or mapping that links public key hashes or contract hashes (e.g., sequence identifiers) to token balances. This mapping allows validators to keep track of ownership and the distribution of tokens across the network. Certain tokens within the blockchain may serve as gas tokens. The gas tokens may be designated by the genesis block. Validators may accept these gas tokens as payment for including transactions in blocks, thus incentivizing validators to process transactions efficiently. The genesis block may contain initial balances of tokens to help bootstrap the system. Alternatively, or additionally, may be used to bring or take token balances into or out of the blockchain from another blockchain. Bridges may be user to connect isolated blockchain ecosystems, allowing the seamless transfer of assets and data between them, facilitating greater interoperability and functionality within the decentralized space.

The participants 130 may be configured to implement multiple chains of the blockchain network architecture 100. For example, the participants 130 can implement a plurality of chains of the blockchain network architecture 100, such as an asset blockchain (e.g., for creating new assets, asset exchange, cross-subnet transfers), metadata blockchain (e.g., for coordinating validators, tracking active subnets, and creating new subnets), smart contract blockchain (e.g., for creating smart contracts and applications that require total ordering), etc. Each of the plurality of chains may be associated with a specific LLM or LLM version.

The network 150 may include any one or more of a wired network (e.g., via fiber optic or copper wire, telephone lines, and the like), wireless network (e.g., a cellular network, radio-frequency (RF) network, Wi-Fi, Bluetooth, and the like), a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like, and/or a combination of these or other types of networks.

Database 152 may store relevant information regarding, for example, execution, verification logic and/or rules for implementing protocols, training data, etc. The participants 130 may store data of the blockchain in a peer-to-peer (P2P) and/or distributed ledger fashion in a database 152. In particular, the participants 130 may function in conjunction to autonomously manage the decentralized database(s) of the existing blockchain via the P2P network and a distributed timestamping server of the participants 130. In particular, the participants 130 may function in conjunction with database 152 to autonomously manage a decentralized database(s) of an existing blockchain.

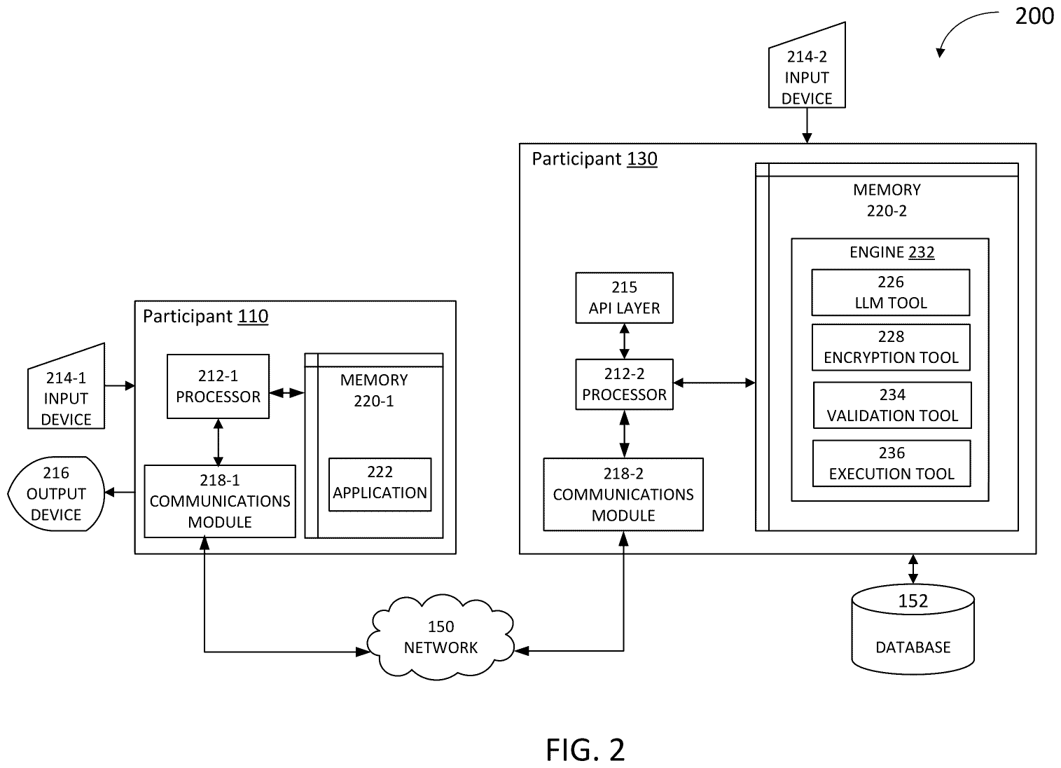

FIG. 2 is a block diagram of an example computing network 200 for use in the network architecture of FIG. 1, according to some embodiments. The example computing network 200 may implement an AI-based blockchain architecture wherein one or more LLMs are embedded in each of the blockchain validators. Participant 130 and participant 110 may be used to operate the AI-based blockchain architecture according to one or more embodiments. The blockchain architecture of the example computing network 200 may include blockchain validators represented by the one or more participant 130 and a plurality of platform blockchains validated and secured by the one or more participant 130. The participant 110 may connect to a blockchain network, allowing users to interact with the blockchain.

Each of the one or more participant 110 and the one or more participant 130 may access each other and other devices in the network 150 via respective communications modules 218-1 and 218-2 (hereinafter, collectively referred to as “communications modules 218”). Communications modules 218 may each include radio hardware and software such as RF antennas, analog circuitry, digital to analog conversion circuits, digital signal processing circuitry, and/or the like. Communications modules 218 are configured to interface with network 150 to send and receive information, such as requests, responses, messages, and commands to other devices on the network 150 in the form of datasets. Participant 110 may be coupled with an input device 214-1 and with an output device 216. Participant 130 may be coupled with an input device 214-2. Input device 214-1 and 214-2 (hereinafter, collectively referred to as “input device 214”), may include a keyboard, a mouse, a pointer, or even a touchscreen display that a user may use to interact with participant 110/participant 130. Likewise, output device 216 may include a display and a speaker with which the user may retrieve results from participant 110.

Participant 110 may also include a processor 212-1, configured to execute instructions stored in a memory 220-1, and to cause participant 110 to perform at least some of the steps in methods consistent with the present disclosure. Processor 212-1 of the participant 110 may be used to operate the participant 110, such as to execute applications and functions thereof rendered on the participant 110. Memory 220-1 may further include an application 222. The application 222 may include specific instructions which, when executed by processor 212-1, cause a dataset from participant 130 to be displayed for the user. Settings of the participant 110 can be defined via user/operator input, such as via an input device 214. The participant 110 can implement, for example, smart contract creation as described herein based on information stored in the application 222. Data and files (e.g., one or more datasets) associated with the application 222 may be stored in database 152.

The participant 110 may be used by a user of the blockchain platform, such as to create a smart contract, perform message transfer, exchange transactions, blockchain validation, block proposal, and other blockchain functions, such as via a graphical user interface (GUI) or display for the user of participant 110. For example, the participant 110 may be coupled to at least one input device 214 and output device 216 accessible by the user (e.g., for user input and output perceivable by the user). The input device 214-1 can include a mouse, keyboard, a pointer, a stylus, a touchscreen display, microphone, voice recognition software, GUI, and/or the like. The output device 216 can include a display (e.g., the same touchscreen displays as the input device), a speaker, an alarm, and the like.

In some embodiments, the participant 110 and/or participant 130 may be operated as a blockchain validator, such as to verify transactions on the existing blockchain. The participant 110 can receive rewards (e.g., cryptocurrency) in exchange for verifying transactions or for participating and staking a network token of the blockchain platform. The participant 110 can be part of a set or list of validators including other validators of the one or more participant 110.

Participant 130 includes an application programming interface (API) layer 215, which controls application 222 in each of participant 110. API layer 215 may also provide instructions, procedural information, updates, or the like to participant 110 as, e.g., new features are uploaded in the application 222 (e.g., newly added features or pharmacy notices like closures, etc.). Participant 130 also includes a memory 220-2 storing instructions which, when executed by a processor 212-2, causes participant 130 to perform at least partially one or more operations in methods consistent with the present disclosure.

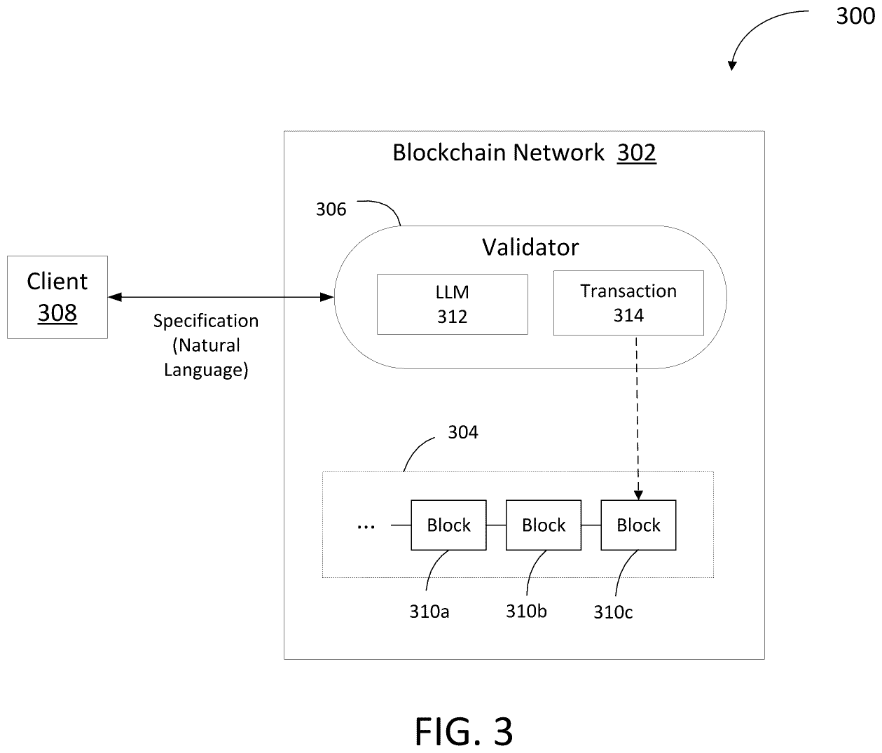

Processor 212-2 may be configured to control application 222 in participant 110. For example, memory 220-1 of participant 110 may be used to perform functions associated with a blockchain platform hosted by participant 130. Processor 212-2 may be used to implement blockchain protocols. Memory 220-2 includes an engine 232. The engine 232 may include computing platform(s) comprising modules configured to perform aspects of embodiments (e.g., described with reference to system 300 in FIG. 3). For example, the engine 232 may include instructions to generate smart contracts and other transactions (e.g., including blockchain assets), as disclosed herein. To do this, the engine 232 may include an LLM tool 226 configured to implement LLM according to aspects of embodiments, an encryption tool 228 configured to encrypt transactions on the blockchain using various cryptographic techniques, a validation tool 234 configured to validate transactions on the blockchain, and execution tool 236 configured to execute a transaction (or actions in transactions) submitted and/or validated on the blockchain. Processors 212-1 and 212-2, and memories 220-1 and 220-2 will be collectively referred to, hereinafter, as “processors 212” and “memories 220,” respectively.

The LLM tool 226 may be part of one or more AI/ML models stored in the database(s) 152. In some embodiments, at least one or more training archives or machine learning models may be stored in either one of memories 220. The database(s) 152 includes training archives and other data files that may be used by engine 232 in the training of a machine learning model, according to the input of the user through application 222 and data extracted through the network 150.

The LLM tool 226 may include algorithms trained for the specific purposes of the engine 232 and tools included therein. The algorithms may include machine learning or artificial intelligence algorithms making use of any linear or non-linear algorithm, such as a neural network algorithm, or multivariate regression algorithm. In some embodiments, the machine learning model may include an LLM, Natural Language Understanding (NLU) model, a neural network (NN), a convolutional neural network (CNN), a generative adversarial neural network (GAN), an unsupervised learning algorithm, a deep recurrent neural network (DRNN), a classic machine learning algorithm such as random forest, or any combination thereof. More generally, the machine learning model may include any machine learning model involving a training step and an optimization step. In some embodiments, the database(s) 152 may include a training archive to modify coefficients according to a desired outcome of the machine learning model. Accordingly, in some embodiments, engine 232 is configured to access database(s) 152 to retrieve data and archives as inputs for the machine learning model. In some embodiments, engine 232, the tools contained therein, and at least part of database(s) 152 may be hosted in a different server that is accessible by participants 110/130.

Processor 212-2 may be configured to execute LLM tool 226, encryption tool 228, validation tool 234, and action tool 236 by software; hardware; firmware; some combination of software, hardware, and/or firmware; and/or other mechanisms for configuring processing capabilities on processor 212-2. As used herein, the term “tool” may refer to any component or set of components that perform the functionality attributed to one or more aspects of embodiments. This may include one or more physical processors during execution of processor readable instructions, the processor readable instructions, circuitry, hardware, storage media, or any other components.

Memories 220 may store instructions and processors 212 may be configured to execute the instructions to perform, at least partially, one or more steps as described in methods according to one or more embodiments. For example, memory 220-1 of participant 110 may be used to perform functions associated with the blockchain platform hosted by the participant 130, such as functioning as a validator node or VM to maintain the integrity of the existing blockchain, a relayer, and/or other entity. The participant 110 can be one of a plurality of validators (or nodes) that may be organized into a small list of validators for randomly sampling proposers of the next block added to the existing blockchain. A list of the subnet's validators can be extracted by the participant 130 from a designated blockchain platform chain.

Although the above description describes certain functions being performed by the processor 212-1 of the participant 110 and other certain functions being performed by the processor 212-2 of the participant 130, all of the functions described herein can be performed by the participant 110 and/or the participant 130 in some other alternative division of labor. It is also understood that participant 110 may include validation information in its memory 220-1, and participant 130 may include proposed blocks and data files in its memory 220-2, such that they have parallel structures.

FIG. 3 is a block diagram illustrating a blockchain system 300 for implementing transactions in a blockchain network 302, according to some embodiments. The blockchain network 302 may include one or more blockchains and/or one or more subnets. For simplicity, one blockchain 304 is shown in FIG. 3.

The blockchain 304 includes several blocks 310a, 310b, and 310c (hereinafter, collectively referred to as “blocks 310”). For simplicity, three blocks 310 in a chain of the blockchain 304 are shown; however, the blockchain 304 may comprise of fewer blocks, more blocks, or more chains. Each of the blocks 310 may contain cryptographic hashes that link the current block to the previous block in the chain, transaction roots that represent the transactions included in the block, timestamps recording when the block was added to the blockchain, etc. The blockchain network 302 may include nodes, which may serve API calls and gossip transactions between other nodes and run blockchain software/protocol. The nodes are responsible for maintaining the distributed ledger, validating transactions, and providing access to the blockchain.

In some embodiments, nodes include non-validator nodes for maintaining the distributed ledger, provide accessibility for users and applications, relay transactions, and contribute to the decentralization of the blockchain network 302. By non-limiting example, non-validator nodes may maintain a complete copy of the blockchain's transaction history and current state. By non-limiting example, non-validator nodes such as relays receive new transactions from clients and broadcast them to validators (i.e., validating nodes) for inclusion in new blocks. Validators are also responsible for producing and/or proposing blocks for addition to the blockchain network 302.

In some embodiments, nodes include validator nodes (e.g., validator 306) which are responsible for verifying transactions and/or maintaining a record of transactions for the blockchain network 302. According to embodiments, the validator nodes may be configured for probabilistic checking of validators' work. For example, when one validator node posts a block, transactions in the block, and a new state root, other validator nodes adopt the block as a given correct state transition after a challenge period has passed.

Client 308 may specify a transaction input in a natural language (i.e., human readable language) to be performed on the blockchain network 302. This initiated a new transaction in the network. According to embodiments, client 308 may correspond to an application, a user, computing device, user interface, or participant (e.g., participant 110) in a transaction. The specification of the transaction is submitted and broadcasted to the blockchain network 302. The specification may be for writing a smart contract. By non-limiting example, the client 308 may specify a smart contract to play chess with another participant.

The validator 306 may include an ML model, and more specifically LLM 312. The validator 306 may take the natural language specification of the transaction and interpret an intent for the transaction using the LLM 312. Specifying the transaction in human readable language also eliminates the burden of having a developer write the equivalent machine-readable code. The free-form nature of specifying transactions give rise to many capabilities that are difficult with traditional blockchain systems. By non-limiting example, a director may be hosting a fundraiser for a cause. A donor may want to donate to the cause, but only if the fundraiser is able to raise a certain amount by a certain date. Using the system 300, the donor can sign a transaction including that natural language clause in it, initiating the transaction in the network. A validator takes that transaction and interprets the intent, using an LLM, to validate the transaction for inclusion in a block (e.g., blocks 310).

According to embodiments, the respective natural language specification input by the client 308 must be supported by the LLM 312. In some embodiments, the system 300 may restrict input specified languages to improve user experience (UX). For example, there are benefits to restricting inputs to widely spoken languages, such that more people can read and follow the sequence of events displayed in chain explorers.

The LLM 312 may include a machine learning model trained on a comprehensive dataset compiled from a variety of sources, enabling the LLM 312 to capture and emulate human knowledge and behavior patterns. The training process allows the LLM 312 to interpret the specification in a manner that closely resembles how a human would, drawing upon the wealth of information contained within the training data. For example, the LLM 312 may be trained by ingesting the available human generated content on the Internet. By processing the specification using the trained LLM 312, the validator 306 can access, rely on, and utilize contextual information that may be associated with the natural language input, even if that information is not explicitly specified by the client 308.

According to some embodiments, contextual information may include high-level abstractions or pre-existing logic that the LLM 312 has learned from its training data. This allows the system 300 to provide more comprehensive and informed interpretations of the specification (i.e., specified transactions or smart contracts). The necessary contextual information is effectively already encoded into the state of the LLM 312 and leveraged to enhance the specification.

According to some embodiments, LLM 312 may include one or more AI models, ML models, and LLMs working together to understand and process human language, understand the context and meaning behind the language, and leverage their learned knowledge to provide contextually relevant transaction in the system 300. In some implementations, multiple LLMs may be utilized to interpret the natural language input. The client 308 may specify in the specification of each transaction whether the transaction should be processed using, for example, one LLM or multiple LLMs. Processing the input using multiple LLMs may result in ambiguous interpretation, and as a result, different actions based on the same specification. According to some embodiments, a resolution protocol is implemented to revert the transaction due to the ambiguity.

According to embodiments, sequences may be used to create separation between concurrent, independent activities to prevent various different uses of the chain from potentially bleeding into each other. A sequence is a serialized set of transactions that instantiate and modify the state of a given LLM, enabling multiple concurrent streams of interactions (e.g., related transactions or interactions with a smart contract) with a single instance of the given LLM. Without proper separations, an unrelated interaction may taint the state of another interaction (e.g., an interaction in a chess game may taint the state of another concurrent game).

In some embodiments, a version of the LLM 312 (e.g., GPT-3, ChatGPT, BLOOM, etc.) is specified in the specification of the transaction and interprets all of the subsequent related transactions. The given LLM may be derived from an initial state of the LLM version specified in a genesis block of the chain. The separate LLM may then deviate from the initial state as a consequence of the transactions that modify that sequence. According to embodiments, new sequences may be assigned unique sequence identifiers (e.g., a number, named identifier, etc.) when the new sequences are created. The unique sequence identifier is used to reference and further interact with (or modify) the respective sequence.

A new sequence may be created by initializing a sequence ID in a transaction specification. For example, a sequence ID of zero indicates that the transaction intends to create a new sequence. In embodiments, there may be no limitation to what sequence ID is used for each new transaction while keeping track of important state modifications (e.g., adding liquidity to a contract, etc.). Once the new sequence is created, a unique sequence identifier is assigned to the new sequence. By non-limiting example, a transaction hash of a transaction with sequence ID 0 initiates a new smart contract, the specification specifies the rules for future interactions with that sequence (in natural language), and the sequence is assigned a unique sequence identifier (different from the sequence ID).

By non-limiting example, the specification may specify that the new sequence implements a lending platform, into which future transactions can deploy collateral against which they borrow other tokens deposited by liquidity providers. The specification may further contain restrictions on who, if anyone, may modify the terms of the contract, fees that the contract would collect, when and how it might liquidate those borrowers whose collateral requirements fall below a threshold, etc. Following this example, future interactions with the lending platform would name the unique sequence identifier that was assigned when the sequence was created. This enables multiple independent sequences to operate on the same chain with state isolation. Further, this enables more advanced fee collection strategies such that certain sequences can be guaranteed space on the blockchain (e.g., the lending platform might need such a guarantee in order to allow people to post collateral), or such that demand for one sequence does not affect the fees for other unrelated sequences.

According to embodiments, the LLM 312 may include and develop preambles which provide precise, unambiguous wording, syntax and semantic context for common tasks. The preambles are used to set the stage, define certain tasks, or provide guidelines for the LLM to follow. In some embodiments, smart contracts may include digital “small print” having boilerplate language to ensure future interactions cannot modify or invalidate the initial clauses including, but not limited to, the creator's (e.g., client 308) initial intent. In some embodiments, the system 300 may incorporate smart contract libraries comprising reusable behaviors that may be added to contracts initiated by users. The smart contract libraries provide reusable implementations of these behaviors and implementations of various standards (prior to contextual information data to the LLM by the client).

In some implementations, the specification may include mathematical equations, computer code, etc., to specify complex mathematical intent in a transaction. By non-limiting example, rather than specifying liquidation conditions in a lending application in the transaction, the client 308 can simply provide a nugget of the liquidation engine from an online resource in the form of a mathematical expression, code script, or the like. This advantageously separates intent from the implementations and avoids imprecision and improves conciseness, however, may require the client 308 to have a level of computer programming knowledge to evaluate intent.

The intent and contextual information determined by the LLM 312 may be used to generate actions corresponding to the rules, constraints, conditions, descriptions, etc., specified in the natural language specification. A transaction 314 may be executed based on the actions. The transaction 314 may be a data packet including the actions and validated natural language specification. The actions may include specific operations, instructions, rules, etc., determined by the validator 306 to constitute the transaction specified by the client 308. The actions may reflect the LLM's understanding of the operations to be performed in order to execute a transaction in accordance with the specification. When executing the transaction 314, the actions may instruct the blockchain 304 to make some type of change (e.g., a transfer of assets or the execution of a smart contract).

In some embodiments, executing the transaction 314 may include validating the transaction 314 and recording the transaction in a block (e.g., block 310c) on the blockchain network 302. In some implementations, the validator 306 may mine a new block corresponding to the transaction 314. Once the new block is validated by the majority of the network nodes, it is permanently added to the blockchain, and the transaction 314 is finalized.

In some embodiments, the LLM 312 may be configured to generate a response output to the client 308. The response may include, for example, a series of natural language constraints or actions that the execution of the transaction 314 will adhere to based at least on the input specification. This provides a level of transparency between the client and the blockchain and avoids actions being taken based on potential hallucinations or incorrect inferences by the LLM. Following the example of the donor wanting to donate based on certain conditions (e.g., only if the fundraiser is able to raise a certain amount by a certain date), LLM 312 may generate a series of constraints defined based on an interpretation of the input. This approach can serve as a secondary verification mechanism to ensure that the client's intent for the transaction and the LLM's interpretation of that intent are properly aligned.

According to some embodiments, the system 300 may define a transaction format that includes specific data fields that enable the efficient execution of the transaction 314. In some embodiments, the transaction format may include at least the following: a fee, a free form field, and a sequence identifier. Each transaction initiated at the blockchain network 302 may carry a fee attached by the client 308 (e.g., as part of the specification). The fee may be used by validator 306 to submit the transaction 314 to the blockchain 304. The free form field may carry the natural language specification. The validators are responsible for executing actions in accordance with the natural language specification in the free form field by feeding the natural language specification through the LLM(s). As described, the sequence identifier indicates an existing related sequence of transactions or indicates that the transaction begins a new sequence.

In some implementations, the fee may be used to determine an order of serialized transactions in blocks, which correspond to the execution order. The fees may act as a deterrent against denial of service (DOS) attacks, as they make it costly for malicious actors to overload the network with spam transactions. By requiring a fee to be paid, the system 300 can distinguish the most economically important transactions from those that are less critical. The fee structure enables load shedding during periods of network congestion, allowing the system 300 to prioritize the most significant transactions and defer less critical ones to a later time when the network conditions are less congested. In some implementations, the transaction fee paid by the user or transaction issuer is equal to the amount they bid or submitted as the transaction fee, following a first price auction mechanism approach. In some implementations, the transaction fee paid by the user or transaction issuer is set to the kth-highest bid within the current block of transactions, rather than their own submitted bid amount, leading to a more robust and predictable kth-price auction mechanism.

The collected transaction fees may be handled in different ways. They can be burned, either in full or in part, effectively removing those funds from circulation. Alternatively, the fees may be distributed as rewards to the validators (e.g., validator 306) who performed the computationally intensive work of processing and verifying the transactions on the network.

In some implementations, the client 308 may submit a transaction that should not be executed if based on one or more fee conditions. For example, a transaction should not be executed if preceded by a higher fee-paying transaction. These conditions may be specified with the transaction or interaction (e.g., “If it is move 17 in the chess game, move bishop to E7” or “trade my X tokens for Y tokens as long as the price offered by the decentralized exchange sequence is 2 Y per X or better.”). The transactions (similar to consensus protocols) may simply order transactions based on offered fees, without notions for failed transactions (e.g., transactions that possess a valid signature but fail to make changes to the global state).

According to embodiments, the system 300 may support deterministic and/or non-deterministic LLMs. In some implementations, LLM instances utilized by validators exhibit determinism and lead to the same sequence of state modifications on validators. To ensure this holds true, non-deterministic LLMs may be built as deterministic components that receive their source of randomness from an external source. For example, random beacons on blockchains have multiple implementation techniques that yield different strengths of randomness and may be leveraged by the system 300. The specific technique used by the LLM may be commensurate with the amount of value secured by the sequence.

In some implementations, functions and operations of system 300 may be performed by one or more program modules in computing platform(s). The computing platform(s) may include electronic storage (e.g., database 152) and a processor (e.g., processors 212) configured to provide information processing capabilities in the computing platform(s), and/or other components. The computing platform(s) may be operatively linked via one or more electronic communication links to remote platforms. The computing platform(s) may include a plurality of hardware, software, and/or firmware components operating together to provide the functionality attributed herein to the computing platform(s). For example, the computing platform(s) may be implemented by a cloud of computing platforms operating together as the computing platform(s).

The remote platforms may include client computing devices, which may each include one or more processors configured to execute computer program modules. The computer program modules may be configured to enable an expert or user associated with the given remote platform to interface with the system 300 and/or external resources, and/or provide other functionality attributed herein to remote platform(s). For example, the external resources may include externally designed blockchain elements and/or applications designed by third parties. In some implementations, some or all of the functionality attributed herein to the external resources may be provided by resources included in system 300.

Electronic storage may include non-transitory storage media that electronically stores information. The electronic storage media of the electronic storage may include one or both of system storage that is provided integrally (i.e., substantially non-removable) with the computing platform(s) and/or removable storage that is removably connectable to the computing platform(s) via, for example, a port (e.g., a USB port, a firewire port, etc.) or a drive (e.g., a disk drive, etc.). Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by the processors, information received from computing platform(s), information received from the remote platform(s), and/or other information that enables the computing platform(s) to function as described herein.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

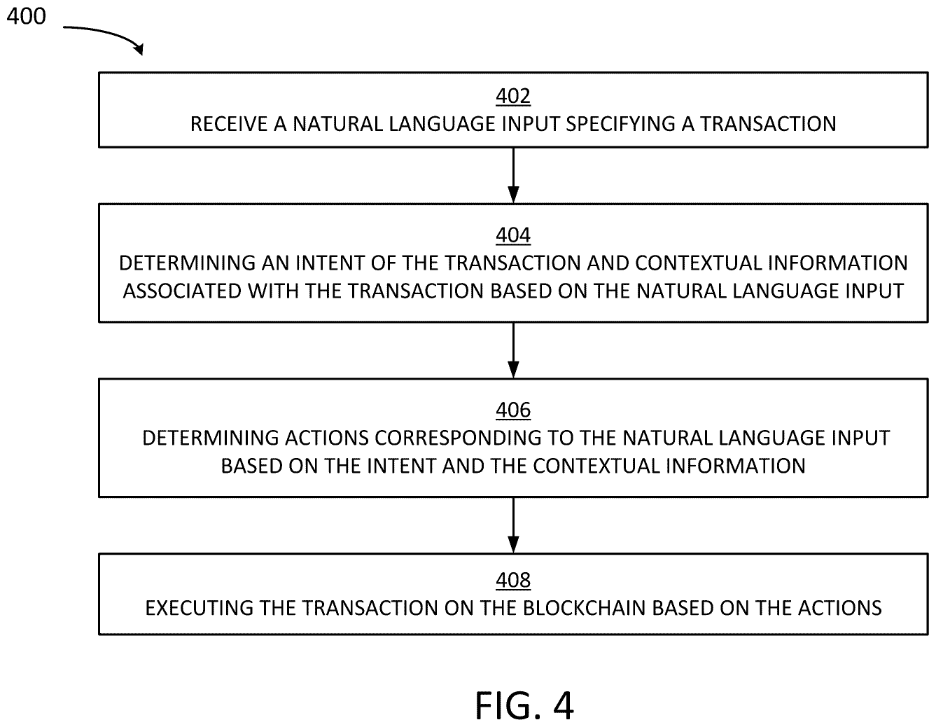

FIG. 4 illustrates an example flow diagram (e.g., process 400) for implementing transactions in a blockchain network, according to certain aspects of the disclosure. For explanatory purposes, the steps of the example process 400 are described herein as occurring in serial, or linearly. However, multiple instances of the example process 400 may occur in parallel, overlapping in time, almost simultaneously, or in a different order from the order illustrated in the process 400. In addition, the blocks of the example process 400 need not be performed in the order shown and/or one or more of the blocks of the example process 400 need not be performed.

At step 402, the process 400 may include receiving (or accepting) a natural language input specifying a transaction to be performed on a blockchain. For example, the transaction may be submitted by a user, broadcasted to the blockchain network, and accepted by a validator node. The validator node may validate the transaction based on, for example, protocols of the blockchain network. In addition to a free form field including the natural language input, a fee and a sequence ID field may be specified in the transaction.

At step 404, the process 400 may include determining an intent of the transaction and contextual information associated with the transaction based on the natural language input. A ML model may be embedded in the validator node and leveraged to interpret the intent of the transaction as specified by the user. The ML model may include a LLM configured for natural language understanding and analysis. According to embodiments, the ML model (or LLM) may be trained on large datasets from the internet, one or more external sources, or the like. The contextual information is encoded into a state of the model based on the training datasets. According to embodiments, the ML model (or LLM) may be trained on at least a natural language used to specify the transaction (e.g., English, Spanish, Japanese, etc.). According to embodiments, a version of the ML model (or LLM) is specified in the transaction.

According to some embodiments, the sequence ID field may relate the transaction to an existing sequence of serialized, related transactions using on a unique identifier associated with the sequence. Each sequence may instantiate a specific instance or version of the LLM. According to some embodiments, a sequence ID of zero creates a new sequence of related transactions and assigns it a new unique sequence identifier. For example, if the transaction specifies an interaction is a sequence ID of 37, the transaction is processed using the same LLM of sequence 37.

At step 406, the process 400 may include determining actions corresponding to the natural language input based on the intent and the contextual information. The actions may include a set of constraints, conditions, or rules. According to some embodiments, the intent of the transaction may be interpreted using multiple LLMs. The transaction may specify that multiple LLMs should be used to interpret the transaction. In some implementations, multiple LLMs may result is different interpretations. Aspects of embodiments may include reverting the transaction based on at least two of the multiple LLMs generating ambiguous actions.

According to some embodiments, the actions as interpreted by the LLM may be output to the user in the natural language. This allows the user to confirm that the actions to be performed when executing the transactions align with the user's intent.

At step 408, the process 400 may include executing the transaction on the blockchain based on the actions, which results in a change in the state of the blockchain maintained by the validator node.

The techniques described herein (for example, process 400) may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

In some implementations, one or more operation blocks of FIG. 4 may be performed by a processor circuit executing instructions stored in a memory circuit, in a client device, a remote server or a database, communicatively coupled through a network (e.g., processors 212, memories 220, participant 110, participant 130, database(s) 152, and network 150).

Although FIG. 4 shows example blocks of the process 400, in some implementations, the process 400 may include additional blocks, fewer blocks, different blocks, or differently arranged blocks than those depicted in FIG. 4.

### Hardware Overview

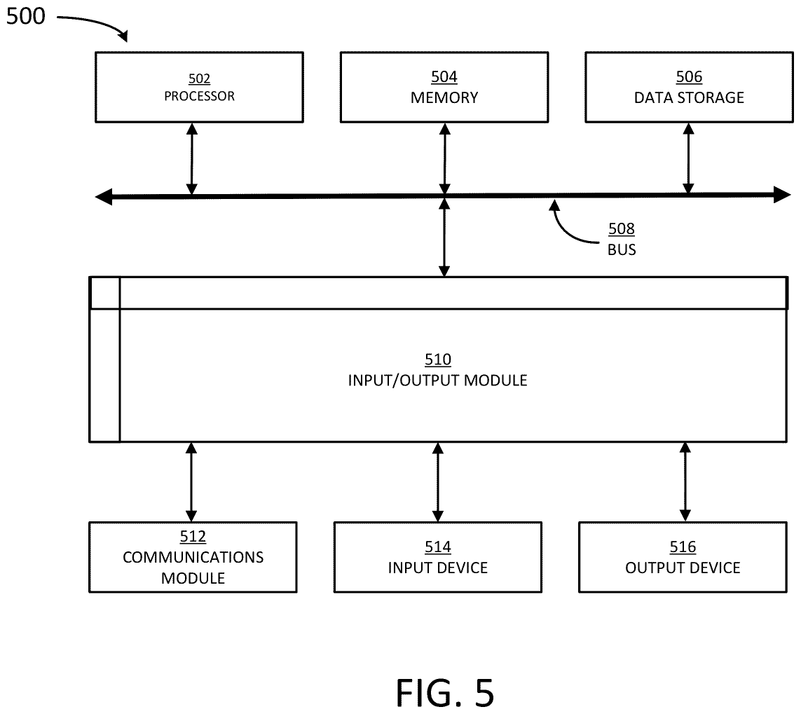

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities.

The computer system 500 (e.g., server and/or participant) includes a bus 508 or other communication mechanism for communicating information, and a processor 502 (e.g., processors 212) coupled with the bus 508 for processing information. By way of example, the computer system 500 may be implemented with one or more processors 502. Each of the one or more processors 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. Processor 502 and memory 504 can be supplemented by, or incorporated in, special purpose logic circuitry.

The instructions may be stored in memory 504 and implemented in one or more computer program products, i.e., one or more modules of computer program instructions encoded on a computer-readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by the processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 500 further includes a data storage device 506 such as a magnetic disk or optical disk, coupled to bus 508 for storing information and instructions. The computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described systems can be implemented using a computer system 500 in response to the processor 502 executing one or more sequences of one or more instructions contained in the memory 504. Such instructions may be read into memory 504 from another machine-readable medium, such as data storage device 506. Execution of the sequences of instructions contained in the main memory 504 causes the processor 502 to perform the process steps described herein. One or more processors in a multi-processing arrangement may also be employed to execute the sequences of instructions contained in the memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 500 can include clients and servers. A client and server are generally remote from each other and typically interact through a communication network. The relationship of client and server arises by virtue of computer programs running on the respective computers and having a client-server relationship to each other. The computer system 500 can be, for example, and without limitation, a desktop computer, laptop computer, or tablet computer. The computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 502 for execution. Such a medium may take many forms, including, but not limited to, non-volatile media, volatile media, and transmission media. Non-volatile media include, for example, optical or magnetic disks, such as the data storage device 506. Volatile media include dynamic memory, such as the memory 504. Transmission media include coaxial cables, copper wire, and fiber optics, including the wires that comprise the bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize user privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the user's privacy settings or preferences. It should also be understood that the original applicant intends that the systems and methods described herein, if implemented or used by other entities, be in compliance with privacy policies and practices that are consistent with its objective to respect the user's privacy.

What is claimed is:

1. A computer-implemented method for implementing transactions in a blockchain platform, the method comprising:
receiving a natural language input specifying a transaction to be performed on a blockchain;
determining, using a machine learning (ML) model, an intent and contextual information associated with the transaction based on the natural language input;
determining actions corresponding to the natural language input based on the intent and the contextual information; and
executing the transaction on the blockchain based on the actions.

2. The computer-implemented method of claim 1, wherein the ML is embedded within validators of a blockchain network.

3. The computer-implemented method of claim 1, wherein the ML model includes a learning language model (LLM) that interprets the natural language input.

4. The computer-implemented method of claim 1, wherein the ML model is trained on large datasets from a plurality of sources.

5. The computer-implemented method of claim 1, wherein the transaction corresponds to a smart contract, and the actions correspond to conditions of the smart contract determined based on the natural language input and the contextual information.

6. The computer-implemented method of claim 1, wherein the transaction is associated with a sequence including transactions that instantiate and modify a state of the ML model, and each sequence is assigned a unique identifier.

7. The computer-implemented method of claim 1, wherein the transaction includes at least one of a fee, a free form field comprising the natural language input, and a sequence identification (ID) comprising a unique identifier associated with a set of transactions.

8. The computer-implemented method of claim 1, wherein a version of the ML model is specified in the transaction.

9. The computer-implemented method of claim 1, wherein a set of transactions are processed using a same version of the ML model.

10. The computer-implemented method of claim 1, wherein the ML model is trained on at least a natural language used to specify the transaction.

11. The computer-implemented method of claim 1, wherein determining the intent and contextual information includes:
interpreting the transaction using multiple LLMs; and
based on at least two of the multiple LLMs generating ambiguous actions, reverting the transaction.

12. A system for implementing transactions in a blockchain platform, comprising:
one or more processors; and
a memory comprising instructions stored thereon, which when executed by the one or more processors, causes the one or more processors to perform:
receiving a natural language input specifying a transaction to be performed on a blockchain;
determining, using a learning language model (LLM), an intent and contextual information associated with the transaction based on the natural language input;
determining actions corresponding to the natural language input based on the intent and the contextual information; and
executing the transaction on the blockchain based on the actions.

13. The system of claim 12, wherein the LLM is embedded within validators of a blockchain network.

14. The system of claim 12, wherein the LLM is trained on large datasets from a plurality of sources and at least a natural language used to specify the transaction.

15. The system of claim 12, wherein the transaction corresponds to a smart contract, and the actions correspond to conditions of the smart contract determined based on the natural language input and the contextual information.

16. The system of claim 12, wherein the transaction is associated with a sequence including transactions that instantiate and modify a state of the LLM, and each sequence is assigned a unique identifier.

17. The system of claim 12, wherein the transaction includes at least one of a fee, a free form field comprising the natural language input, and a sequence identification (ID) comprising a unique identifier associated with a set of transactions.

18. The system of claim 12, wherein a version of the LLM is specified in the transaction and a set of transactions are processed using the version of the LLM.

19. The system of claim 12, wherein determining the intent and contextual information includes:
interpreting the transaction using multiple LLMs; and
based on at least two of the multiple LLMs generating ambiguous actions, reverting the transaction.

20. A non-transitory computer-readable storage medium comprising instructions stored thereon, which when executed by one or more processors, cause the one or more processors to perform operations for implementing transactions in a blockchain platform, comprising:
receiving a natural language input specifying a transaction to be performed on a blockchain;
determining, using a learning language model (LLM) embedded within validators of the blockchain, an intent and contextual information associated with the transaction based on the natural language input;
determining actions corresponding to the natural language input based on the intent and the contextual information; and
executing the transaction on the blockchain based on the actions.
